(19) United States
(12) Patent Application Publication
(10) Pub. No.: US 2004/0060855 A1
(43) Pub. Date: Apr. 1, 2004

(54) Countercurrent web contactor for use in separation of biological agents

(75) Inventors: Ramon L. Cerro, Huntsville, AL (US); Krishnan K. Chittur, Huntsville, AL (US); Douglas G. Hayes, Huntsville, AL (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: University of Alabama, Huntsville, AL

(21) Appl. No.: 10/260,756

(22) Filed: Sep. 30, 2002

(51) Int. Cl. B01D 15/08

(52) U.S. Cl. 210/198.2; 436/161; 530/417; 422/70

(57) ABSTRACT

A web contactor for the purposes of continuous separation of specific proteins from a mixture of proteins comprises an endless, inert, non-porous, flexible web is coated with an activated matrix material which is, in turn, bound to a plurality of ligand molecules. The ligand molecules are chosen to correspond to a desired biological molecule or class of molecules, typically a desired protein. The web is translated over a series of rolls such that it contacts a feed solution of a mixture of biological molecules in a countercurrent manner. During contact of the web and solution, the ligand molecules which are attached to the web matrix, selectively bind to the protein or other biological molecule which are to be separated from the feed solution mixture.

### FIELD OF THE INVENTION

The invention relates to a method of separating specific biologically active components from a mixture of biologically active components or a heterogeneous mixture of active and inactive components. The invention further relates to the process of binding a ligand to a substrate and using the ligand to bind specific components.

### BACKGROUND OF THE INVENTION

It is often desirable to separate one or more biological components from a mixture of such components. Such separations may be important to research, process quality control, or production of specific biological materials, such as pharmaceuticals.

Affinity chromatography is typical of techniques used to separate biological components from mixtures of biological molecules. Affinity chromatography can take advantage of the characteristic of many proteins to specifically bind particular molecules tightly, but non-covalently. In this technique, a particular ligand is first covalently bound to an underlying matrix. The ligand has a natural affinity for a particular protein or class of proteins. When a mixture of proteins in solution are passed over the ligand covered matrix, the desired protein becomes bound to the ligand. The remaining, undesired proteins come into contact with the matrix, but are unaffected by the ligand. After the desired protein molecules are collected by the matrix-bound ligand molecules, the desired protein can then be recovered in highly purified form by changing solvent conditions around the matrix in order to promote elution of the protein.

Affinity chromatography depends upon the unique biochemical activity of the desired molecules rather than small differences in physical properties or general chemical activity. Separation by biochemical means is necessary because proteins cannot be separated by conventional methods due to heat, shear, pH variation, etc., which tends to destroy the proteins. Affinity chromatography is unique because it uses specific ligand molecules to interact with the proteins. The ligand molecule forms a complex with the active site of the protein or with a specific region of the protein surface. This specific, reversible, strong binding is very similar to the natural interactions of proteins in vivo. Because molecular binding interactions differ between classes of proteins, and even individual proteins, separations of proteins can be made with tremendous specificity using affinity chromatography techniques.

Traditional affinity chromatography is a batch operation carried out by first binding ligand molecules to an activated porous matrix material, such as agarose. The ligand-bound matrix is provided in the form of beads or other shapes which may be placed within a column and which provide a large surface area for contact with a solvent containing a mixture of proteins. The protein containing solution is then flowed through the column and around the matrix. As the solution flows in and around the porous matrix, the desired protein is bound to the matrix by the ligand molecules while the remaining solvent and protein mixture flows out of the column.

Affinity chromatography has limitations that are only now becoming problematic for the biotechnology industry. The most notable of such limitations relate to the adsorption gradient and the elution gradient of the chromatographic column. As protein mixtures flow downward through the column of ligand-bound matrix beads, the ligands of the beads at the top of the column rapidly bind to target protein molecules. As the ligands at the top of the column become loaded with the target protein, efficient separation of the proteins at the top of the column decreases. Similarly, target proteins in the initial loading of protein solution bind to the ligands at the top of the column and are unavailable for separation by the ligands of the lower portion of the column, leading to inefficient separation during the initial loading of the protein mixture. Similarly, when eluent is introduced downward into the column, the eluent rapidly loads with proteins bound to the ligands at the top of the column. This initial protein loaded eluent does not effectively remove proteins from the lower portion of the column. Extra eluent is required in order to remove proteins from the ligands of the lower region of the column. Thus, traditional means of affinity chromatography have inherent inefficiencies.

Because protein separations have traditionally occurred in research laboratories and with relatively small samples of proteins, inefficiencies in affinity chromatography have not heretofore limited the usefulness of the process. However, recent developments in biotechnology and pharmaceuticals are beginning to require large volumes of highly purified proteins. Because of economic considerations, it will no doubt be desired that these highly purified proteins be produced in the most cost effective and, therefore, the most efficient manner possible.

It is desired to provide a method of separating proteins from a protein mixture which is both faster and more efficient than currently available methods of protein separation, such as traditional affinity chromatography. Such method should be capable of highly specific protein separation.

### BRIEF SUMMARY OF THE INVENTION

The invention provides a continuous, steady-state method of and apparatus for separating specific proteins or groups of proteins from a mixture of proteins or other components. Under continuous, steady-state conditions, the apparatus and method remove proteins from a mixture through use of ligand molecules bound to a continuously moving matrix which have specific biochemical attraction to the proteins to be separated from the mixture.

In one embodiment, the apparatus is an endless, inert, non-porous, flexible web supported by a plurality of rolls and advanced countercurrent to the flow of a feed solution. The web is coated with an activated matrix material which is, in turn, bound to a plurality of ligand molecules. The ligand molecules are chosen to correspond to a desired biological molecule or class of molecules, typically a desired protein. A feed solution of biological molecules is provided to a vessel. The solution flows through the vessel and leaves the vessel as a residue stream. The web is fed into the vessel and retracted from the vessel such that the web contacts the flow of feed solution in a countercurrent manner. During contact of the web and solution, the ligand molecules that are attached to the web matrix selectively bind to the protein or other biological molecule which are to be separated from the feed solution mixture.

Through use of the invention, proteins may be continuously removed from a continuously flowing mixture of proteins. Because the proteins may be continuously separated according to the method and with the apparatus, large volumes of proteins may be separated at extremely high purities without the inefficiencies associated with the batch operation of traditional affinity chromatography.

The continuous nature of the invention makes the invention readily applicable to industrial production lines, particularly for the production of biochemical, biomedical, and pharmaceutical products. In addition, the apparatus is scalable and has is capable of extremely large volume separations resulting in protein solutions of extreme purity.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a representation of an embodiment of the invention which uses a single loading vessel and a single elution vessel;

FIG. 2 is a representation of the web of the invention coated with a matrix material;

FIG. 3 is a representation of an embodiment of the invention having a washing vessel;

FIG. 4a is a representation of a counter-current contacting vessel in accordance with a first embodiment of the invention;

FIG. 4b is a representation of a counter-current contacting vessel in accordance with a second embodiment of the invention;

FIG. 4c is a representation of a counter-current contacting vessel in accordance with a third embodiment of the invention; and

FIG. 5 is a representation of an embodiment of the invention having dual adsorption vessels and dual elution vessels.

### DETAILED DESCRIPTION OF THE INVENTION

The invention will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

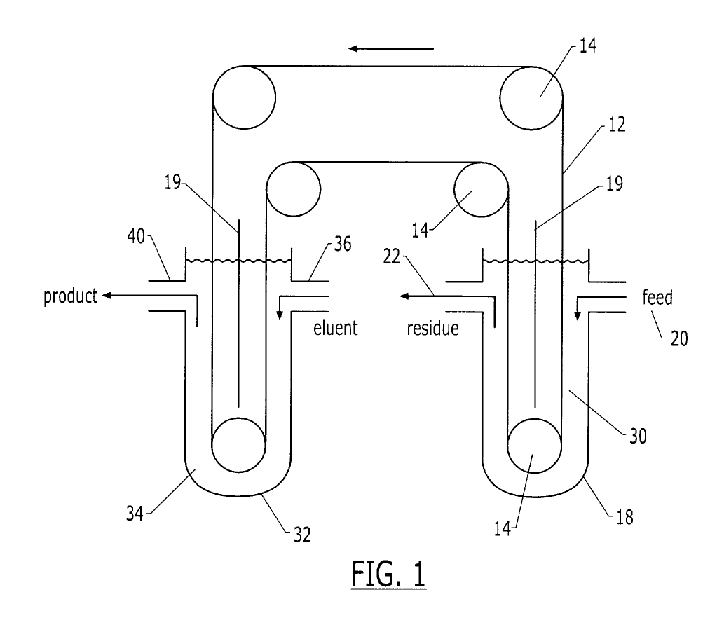

Referring to FIG. 1, the invention comprises a web 12 which is made of an inert, nonporous, flexible material which is formed into an endless flattened loop and suspended about rolls 14. The web material is preferably polymeric, such as PET (polyethylene terephthalate), polyethylene, polyester, etc., but may also be a metal based thin web, such as stainless steel or a titanium alloy. An exemplary web is the PET web commonly used to build 35 mm photographic film, which is about 35 mm wide and about 0.5 mm thick. The width of the web is proportional to the surface area contacted with a solution and is therefore proportional to the separating capacity of the invention.

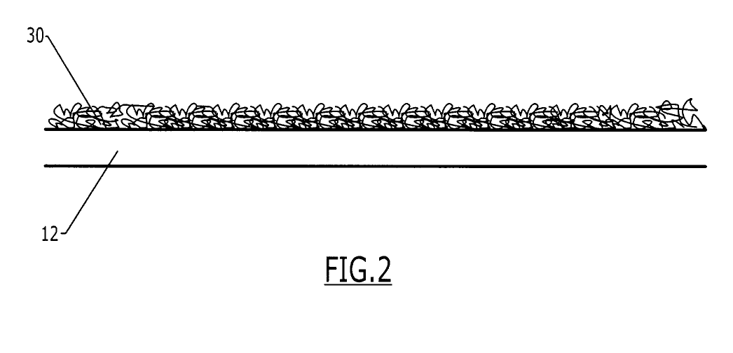

Referring to FIG. 2, the web 12 is coated with a porous matrix material 30. The purpose of the porous matrix material is to increase the surface area of the matrix available to proteins within the mixed solution. Because the proteins to be removed are large molecules, the pore size of the matrix must be relatively large, usually in the range of about 10 nm to 100 nm, in order for the molecules within the solution to enter and exit the pores of the matrix. The size of the pores is determined by the type of matrix material used and the manner and thickness with which the matrix is applied to the web 12.

The matrix 30 may be any material which provides pore size suitable to the proteins to be removed from the liquid, and which provide acceptable binding qualities for the ligands which are to be attached to the matrix. Also, the matrix material should be stable under the reaction conditions required for adsorption and elution of the proteins. Exemplary matrix materials include polysaccharide gels such as agarose gels and cellulose gels, synthetic polymer gels such as polyacrylates and polyvinyl alcohol, and protein gels such as collagen gels. Exemplary matrix materials also include porous solid particles such as hydroxyapatite and alumina, deposited in the form of a slurry, dried and calcined onto the web.

Agarose is a suitable coating which may be used to form the matrix 30 which is applied to the web. Agarose is a natural product which can be activated relatively easily for connection of ligands and which forms a gel of suitable strength to withstand the physical stresses of the moving web. An exemplary agarose coating is D-5 agarose. Commercial agarose is a solid white powder.

For application to the web, an agarose powder is dissolved in a weak acid buffer solution, such as a 0.05 molar boric acid-sodium borate buffer solution, under heat, typically about 90° C. The concentration of the gel can vary from about 0.8% to about 4% of agarose by weight of the matrix solution.

In general, the web 12 is coated by heating the matrix solution to a temperature above its gelling temperature, dipping the web 12 within the heated matrix solution, and cooling the matrix solution to form a gel coating upon the web 12. To control the thickness of the matrix 30 upon the web, the web is slowly removed from the matrix solution as the matrix gels, such that a layer of matrix 30 is formed upon the web 12. The degree to which the gel has cooled, the speed with which the web is removed from the matrix material, and the type of matrix material each determine the resultant thickness of the matrix coating layer upon the web. To provide a more uniform thickness of matrix, a pre-metered coating method may be used, such as slot coating, where the matrix material is forced through a coating die on the substrate, curtain coating, where a matrix material sheet is deposited on the moving web substrate, or by knife or roll coating where the excess of coating matrix material deposited on the web is removed by a rigid knife held in proximity to the rigidly supported web or by forcing the web previously coated through a gap between two rotating rolls.

In the case of an agarose coating, the endless web 12 is coated by dipping it into the agarose solution and then cooling it below the gelling temperature of agarose, which is about 36° C. The web 12 is then removed vertically upward at a continuous speed. As the web comes out of the liquid agarose, a thin layer of agarose remains on the web surface. This layer cools down and gels within a few centimeters from the liquid interface. The coating thickness of the matrix upon the web 12 is a direct function of the removal speed of the web from the solution. The more rapid the removal speed, the larger the thickness of the agarose coating. Using very slow removal speeds, it is possible to get web coating thickness on the micron range.

After the web 12 is coated, it is cooled to room temperature and immersed in a weak acid-buffer solution, such as a boric acid-sodium borate buffer solution, to avoid dehydration. If the web is to be stored for an extended period, it may be preserved by refrigeration. For instance, an agarose coated web 12 may be preserved by refrigeration at temperatures lower than about 5° C. Although dehydration is a problem with the gel matrices, dehydration is not considered a problem with solid coatings.

Prior to the attachment of ligands to the matrix, the matrix is activated so that the ligand may be properly fixed to the matrix. In order to separate proteins from a mixture, the matrix material and the method of activation must cooperate to bind the particular protein being removed from the mixture. The process of preparing a matrix for use in protein separation has three steps: (1) creation of active sites upon the matrix, (2) choice of a spacer arm-ligand molecules for use in separating the proteins, and (3) coupling of the spacer arm-ligand molecules to the active sites.

The creation of the active sites is accomplished by a chemical reaction between a reagent and the matrix material. “Activation” is a general term which means altering the chemical nature of sites within the matrix so that they will readily react with and bind to a spacer-arm molecule. The mechanism of activating any particular matrix will depend upon the type of matrix being activated, the functionality of the spacer-arm being attached to the matrix, and the type of ligand that is attached to the spacer arm. Exemplary activating groups include cyanogen bromide (CNBr), thiolpropyl, thio, tresyl, epoxy, aminohexyl, carboxylhexyl, and triazine. Some matrix gels may also be activated by using activating groups with C═C and/or C═O bonds.

In the case of an agarose matrix, CNBr may be used as an activating group. For example, a solution of 0.15 g/ml of CNBr may be used to completely cover the agarose matrix. The pH of the solution is then raised suddenly to a pH of about 11, such as by addition of an 8 molar solution of sodium hydroxide (NaOH). The pH may be maintained throughout the reaction by the continuous addition of a base, such as sodium hydroxide to the solution. The reaction of the agarose with CNBr is assumed to be complete after about 20 minutes. Due to the noxious nature of the cyanogen bromide, operations involving CNBr should take place under a hood. After treatment with the CNBr, the activation of the agarose is stopped by addition of cold water or ice to the CNBr/base solution. The activated web is then removed from the reagent and washed repeatedly with a cold, mild alkaline type solution, such as a 0.5 M solution of sodium bicarbonate.

The choice of spacer arm and ligand is determined by the choice of protein to be separated from a mixture of proteins. The spacer arm is a long chain molecule that tethers the ligand to the matrix, and allows the ligand to extend from the surface of the matrix to a distance such that large protein molecules can be accommodated without interfering with the matrix. Typically, the spacer arm is a carbon chain of about 6 to about 20 carbons in length having a functional group at each end. One functional group is used to attach the spacer arm to an activated site on the porous matrix, and the other is used for attachment to the ligand. The functional groups for the spacer arms are typically either carboxyl groups or amine groups.

The ligand is a very specific chemical molecule which is be bound to the spacer-arm molecule, that has a particular affinity with the protein to be removed from solution. In general the ligand may be group specific, meaning that the ligand may be used to isolate whole families of biomolecules which have common properties, or the ligand may be specific to one or a handful of proteins. Both group specific ligands and protein specific ligands are known in the art of traditional affinity chromatography. Further, as ligand and protein interactions are explored, more and more ligand/protein interactions will be documented. In some cases, an antibody may be used as the ligand to provide extreme specificity. A sample of known ligand/protein interactions is shown below in Table I.

TABLE I
Ligand Specificity

| Ligand | Specificity |
|---|---|
| NAD, NADP | Dehydrogenases |
| Lectins | Polysaccharides |
| Poly(U) | Poly(A) |
| Poly(A) | Poly(U) |
| Histones | DNA |
| Protein A | Fe antibody |
| Protein G | Antibodies |
| Lysine | rRNA, dsDNA, plasminogen |
| Arginine | Fibronectin, prothrombin |
| Heparin | Lipoproteins, DNA, RNA |
| Blue F3G-A | NAD⁺ |
| Red HE-3B | NADP⁺ |
| Orange A | Lactate dehydrogenase |
| Benzamidine | Serine proteases |
| Green A | CoA proteins, HAS, dehydrogenases |
| Gelatin | Fibronectin |
| Polymyxin | Endotoxins |
| 2′,5′-ADP | NADP⁺ |
| Calmodulin | Kinases |
| Boronate | Cis-Diols, tRNA, plasminogen |
| Blue B | Kinases, dehydrogenases, nucleic acid-binding proteins |

Once the matrix sites have been activated and the spacer arm—ligand combination has been chosen, the spacer arm—ligands may be attached to the activation sites by reaction in an appropriate buffer solution. The process of spacer arm attachment to activated sites on a porous matrix is analogous to those procedures known in the art of traditional affinity chromatography, and the same procedures can be used in the context of this invention.

After attaching the spacing arm and ligand to the matrix, excess ligand may optionally be removed from the matrix and unreacted sites upon the matrix may optionally be blocked. Some of the ligand will remain unreacted and unattached to the matrix after reacting the spacer arm and ligand with the matrix. Similarly, some of the activated sites upon the matrix will remain unreacted. Because the unreacted active sites may bond unfavorably to proteins, and because the unattached ligands do not serve to separate proteins from the mixture, it is favorable to block the unreacted sites of the matrix and to remove the unattached ligands. Unreacted sites upon the matrix are blocked by exposing those sites to reagents having opposite charge to the sites or which can be covalently linked to the sites. The excess ligands may be removed by washing the matrix with a buffer solution. Once the ligands have been attached to the matrix, the web is stored until ready for use.

When used in separation of proteins, the web is maintained under buffer conditions, such as 0.1 to 0.2 M phosphate or tris buffer solutions containing salts such as 0.5 M sodium chloride. The choice of buffer is based on the desired interaction of the ligand and proteins. For separations which are based upon an agarose matrix, a boric acid-sodium borate buffer solution is favorable. An exemplary buffer solution for use with agarose is 0.1 M boric acid with 0.5 M sodium borate.

Referring to FIG. 1 again, when in use, the coated web 12 is moved slowly around rolls 14. During a portion of the webs traversal around the series of rolls 14, the web is immersed within a buffer solution 30. The buffer solution 30 contains a mixture of proteins inputted to a loading vessel 18 through a protein feed 20. The buffer solution 30 and the proteins within the mixture travel through the loading vessel 18 and contact the moving web 12. Although the apparatus may be operated such that the various solutions of the invention contact the web in a co-current, it is generally preferred that the various solutions of the invention contact the web 12 in a countercurrent manner, thereby countercurrent flow is discussed in detail throughout the disclosure. Countercurrent flow is most easily accomplished by suspending a baffle 19 within the vessel 18 as depicted in FIG. 1.

During contact with the web 12, proteins from the protein mixture specifically react with the ligands maintained upon the surface of the web 12. The protein mixture, which is suspended in the buffer solution 30, maintains contact with the web 12 until the mixture and the buffer leave the loading vessel 18 through a residue outlet 22. Thus, the desired protein or family of proteins is selectively removed from the protein mixture in a countercurrent manner.

The speed of the web and the flow rate of the buffer 30 may vary widely depending upon the strength of interaction between the ligand and the protein to be separated and also depending upon the desired degree of separation. In general, flow rate of the buffer 18 and speed of the web will be adjusted such the buffer and web 12 encounter one another at a rate of about 10 cm/hr to about 500 cm/hr, in terms of linear speed. In terms of efficiency, the web and protein-containing buffer solution should be contacted at the highest practical rate which provides for the desired level of protein separation.

After the web 12 leaves the loading vessel 18, the loaded web 12 is advanced via the rolls 14 to an elution vessel 32. It is the purpose of the elution vessel 32 to remove the protein from the ligands of the web. The elution vessel 32 is filled with eluent 34 which flows from an elution inlet 36 to an elution outlet 40 such that the eluent 34 flows in countercurrent direction with respect to the moving web 12. The eluent may be either a specific or non-specific eluent. A specific eluent is a solution which has a greater affinity for a ligand then the protein which is bound to that ligand. Thus, the specific eluent displaces the protein on the ligand and the protein is driven off into the eluent solution. A non-specific eluent is a solution with a temperature, pH, or other characteristic which causes the protein to be driven from the ligand without replacing the protein component upon the ligand. Exemplary eluents are shown below in Table II.

TABLE II
Elution Conditions

| Ligand | Eluent | Specific | Nonspecific |
|---|---|---|---|
| Protein A | Acetic acid | | X |
| | Glycine | | |
| ConA | α-D-Methylmannoside | X | |
| | Borate buffer | | X |
| | α-D-Methylglucoside | X | |
| Lysine | Temperature | | X |
| | Salt | | X |
| Blue dye | Salt | | X |
| | Urea | X | |
| Gelatin | Arginine | X | |
| | PH | | X |
| 5′-AMP | NAD⁺, NADP⁺ | X | |
| | Salt | | X |

Under normal operating conditions, the eluent 34 removes substantially all of the proteins from the ligand upon the matrix of the web 12 without leaching the ligands from the matrix itself. After removal of the protein, the matrix is optionally cleaned before being recirculated into the loading vessel 18.

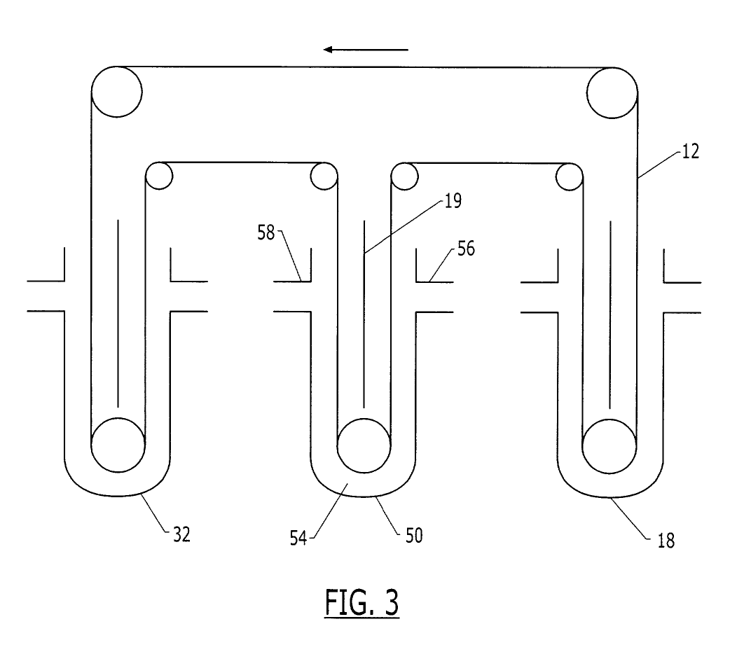

Referring to FIG. 3, an embodiment of the invention is shown in which the coated web 12 is advanced around rolls 14. During a portion of the webs traversal around the series of rolls 14, the web is immersed within a loading vessel 18 as previously shown in FIG. 1. The loading vessel 18 contains a buffer solution which contains a mixture of proteins and which travels through the loading vessel 18 countercurrent to the motion of the web 12. During contact with the web 12, proteins from the protein mixture specifically react with the ligands maintained upon the surface of the web 12. The desired protein or family of proteins is selectively removed from the protein mixture and bound to the ligands of the web 12 until the mixture and the buffer leave the loading vessel 18.

After the web 12 leaves the loading vessel 18, the loaded web 12 is advanced via the rolls 14 to an elution vessel 32. As in FIG. 1, the elution vessel 32 is filled with 20 eluent which flows from an elution inlet to an elution outlet such that the eluent flows in countercurrent direction with respect to the moving web 12.

A washing vessel 50 is positioned such that the web 12 travels through a washing solution 54 subsequent to elution, but prior to being reloaded within the loading vessel 18. The washing solution 54 is generally similar to the chosen elution solution, but of higher concentration, pH, temperature, etc. The washing solution 54 is introduced into the washing vessel 50 through the washing inlet 56 and expelled from the washing vessel 50 through the washing vessel outlet 58, thereby moving countercurrent to the motion of the web 12. Countercurrent flow of the web and washing solution 54 is further facilitated by a baffle 19 positioned within the washing vessel 50. The purpose of the washing solution is to remove any proteins remaining within the large pores of the web after elution. The washing solution 54, has a concentration, pH, temperature, etc. which causes the washing of the residual proteins from the ligands without causing the spacer arm—ligand molecules from becoming separated from the matrix.

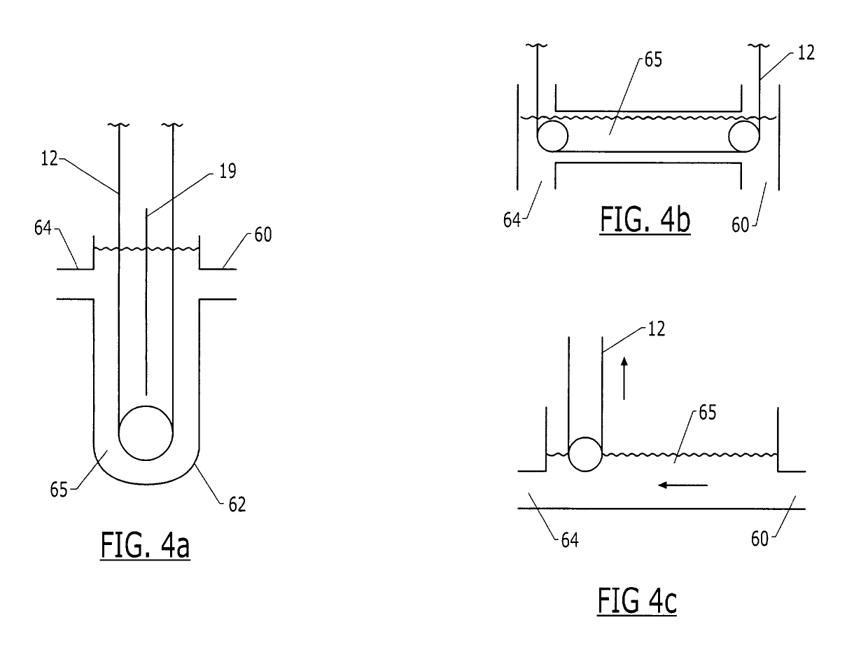

Referring to FIGS. 4a, 4b, and 4c, loading, eluent, and washing 18,32,50 vessels may be configured in a variety of ways such that flowing solution 65 is exposed to the moving web 12 in a countercurrent manner. The vessels will generally have solution inlets 60 and outlets 64 which provide a flow of solution through the vessel. A baffle 19 or other divider may be used within the vessel to direct the flow of solution. In general, an arrangement such as that shown in FIG. 4a is suitable to the contactor due to the relatively large amount of web surface area exposed to the solution at any particular time during operation. Contacting of smaller surface areas, such as shown in FIG. 4b and particularly in FIG. 4c may desired in situations where a short residence time of the web in solution is desirable, such as when the web provides for extraordinarily rapid absorption of target proteins from the solution or when a washing solution is used that tends to damage the matrix upon prolonged exposure.

The resulting method provides a means to remove specific proteins from a mixture of proteins using biospecific separation techniques that may be carried out in a continuous manner. By continuously separating the proteins, the apparatus and method may be incorporated into highly efficient industrial and laboratory techniques which require a continuous supply of particular proteins.

### EXAMPLES

### Example 1

Activation of Matrix to Allow for Attachment of Spacer Arm—Ligand Block

A 0.5 mm thick PET web is supplied with a D-5 agarose coating which is approximately 0.1 mm thick. The agarose matrix is completely covered with a solution of 0.15 g/ml of CNBr. The pH of the solution is then raised suddenly to a pH of about 11 by addition of 8 M NaOH. The pH is maintained throughout the reaction by the continuous addition of sodium hydroxide to the solution. The CNBr is allowed to react with the matrix for 20 minutes, after which cold water is added to the CNBr/base solution. The activated web is then removed from the reagent and washed repeatedly with a cold 0.5 M solution of sodium bicarbonate (NaHCO₃).

### Example 2

Creation of Spacer Arm—Ligand Block

A spacer arm-ligand block is made by reacting hexamethylenediamine with L(+)-chlorosuccinic acid. A large excess, about 2.5 times the stoichiometric ratio, of hexamethylenediamine is melted in a thermostated batch reactor at 45° C. The L-(+) chlorosuccinic acid is then gently added while mixing. The mixture is left at 40° C. for 80 hours under magnetic stirring. Subsequently a large amount of water is added to the oily product and the resulting mixture is then concentrated in a rotary evaporator. The initial amount of water is about 100 ml per 20 micromoles of component. This solution is then evaporated down to about ⅛ of its initial volume. This operation of adding water and then evaporating the excess, was repeated three times to eliminate the excess of nonreacted hexamethylenediamine. Next a 0.5 M solution of sodium bicarbonate is added in a proportion of 2.5 ml per milliliter of the reacted solution. The pH of the mixture is then adjusted to 8.5 by adding a solution a 2 N hydrochloric acid solution (HCl). The result of this reaction is an amino-succinic spacer arm-ligand block compound.

### Example 3

Coupling Spacer Arm—Ligand Block to Matrix

To couple the spacer arm-ligand blocks to the agarose active sites, the web coated with active agarose is immersed into the amino-succinic compound solution. The container where this operation takes place is gently shaken for 2-3 hours and then washed extensively with a 0.1 M sodium borate-sodium acetate buffer solution to desorb any material not bounded covalently to the active sites.

The amount of active sites created by reaction with cyanogen bromide and the amount of active spacer arm-ligand blocks attached to them was then determined by a standard method (Kjeldahl, 1986). Typically, this process will render about 30 micromoles of active CN+ sites per mol of agarose and about 25 micromoles of amino-succinic blocks per g of agarose.

### Example 4

Continuous Contact Between Agarose-Coated Substrate and Protein Solutions.

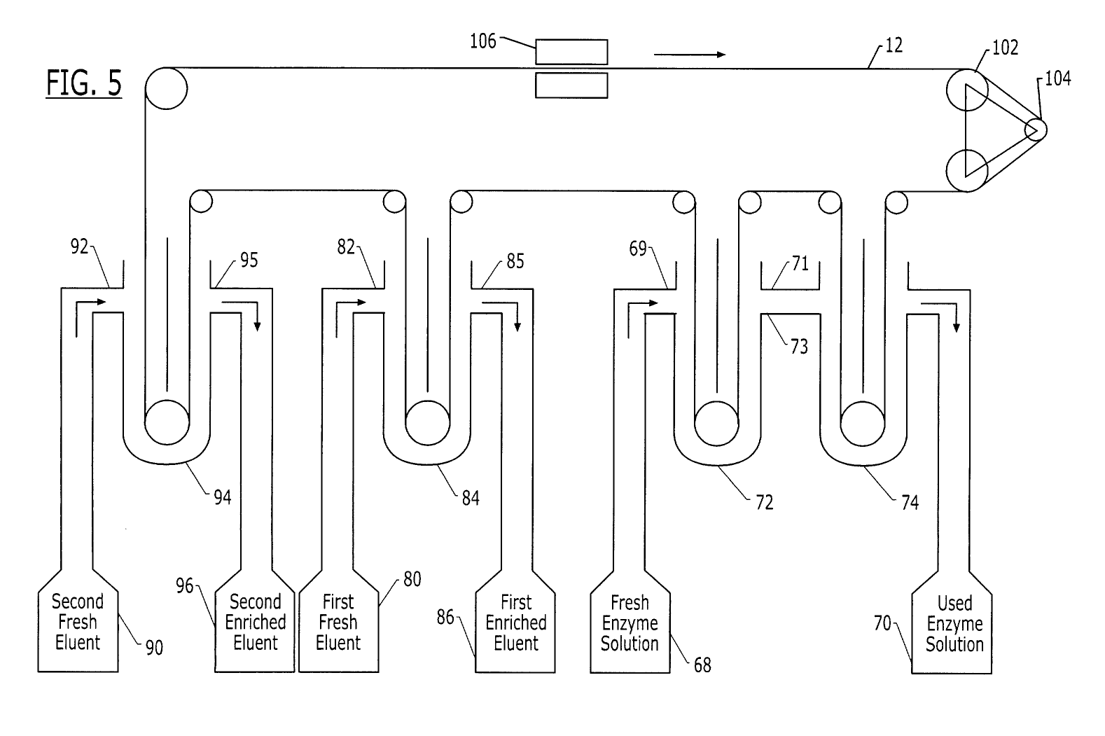

The web of Example 3 could be used to perform a sharp separation of a mixture of asparaginase and trypsin. The web coated with agarose, activated and treated with amino-succinic compound is wound around sprocketed wheels, a driving mechanism, and tensors as shown in FIG. 5. A buffer solution containing a fresh enzyme mixture 68 of 0.5 units/ml (about 0.043 mg/ml) asparaginase and about 0.06 mg/ml trypsin is supplied to a first adsorption vessel 72 via an inlet 69, and allowed to leave the first adsorption vessel 72 through an outlet 71 into an inlet 73 of a second adsorption vessel 74. The enzyme mixture then leaves the second adsorption vessel 74 as a used enzyme solution 70. The combined volume of the first 72 and second 74 adsorption vessels is approximately 50 cm³.

The buffer which contains the mixture 68 of asparaginase and trypsin is pumped at a rate of 12 ml/min. The buffer is a solution of 0.1 M boric acid with 0.5 M sodium borate, has a pH of 8.6, and contains 0.06 mg/ml of trypsin and 0.5 units of asparaginase per ml.

The web 12 of Example 3 is threaded upon sprockets and continuously traversed through the second adsorption vessel 74, and then the first adsorption vessel 72, such that the web moves counter-current to the flowing buffer solution 68. The speed of the web 12 is approximately 1 mm/s. The time it takes the web 12 to move in and out of a vessel is approximately 200 seconds, and it takes the web 12 about 80 seconds to go from one vessel to the next. While the web 12 is in contact with the buffer solution and protein mixture, the web adsorbs asparaginase selectively on the affinity sites and very small quantities of a mixture of asparaginase and trypsin become physically trapped within the large pores of the matrix. The adsorbed asparaginase saturates approximately 50% of the active affinity sites of the agarose on the web, and the remaining affinity sites remain unoccupied.

A first supply of fresh eluent 80 is supplied to the inlet 82 of a first elution vessel 84 and allowed to flow through the first elution vessel to an outlet 85 of the vessel before leaving the vessel as a first enriched eluent 86. Similarly, a second supply of fresh eluent 90 is supplied to the inlet 92 of a second elution vessel 94 and allowed to flow through the second elution vessel to an outlet 95 of the vessel before leaving the vessel as a second enriched eluent 96. The eluent is a 1.5 M solution of NaCl that is pumped continuously and independently through the two elution vessels 84, 94. The saline solution is independently pumped through the vessels at a speed of 20 ml/min.

The web 12 moves from the second adsorption vessel 72 to the first elution vessel 84 through which it moves countercurrent to the flowing first eluent 80. During contact of the web 12 with the saline solution in the first elution vessel 84, asparaginase desorbs from the affinity sites and is carried out by the saline solution.

The saline solution leaving the first elution vessel 84 carries approximately 0.3 units/ml (about 0.0258 mg/ml) asparaginase and no measurable trypsin (less than 0.0005 mg/ml).

Contact of the web 12 with the saline solution of the second elution vessel 94 desorbs essentially all remaining asparaginase from the active affinity sites and removes any of the asparaginase and trypsin which were trapped within the porous matrix. The web 12 leaves the vessel free from enzymes and ready to be used in a new cycle.

The web 12 returns from the second elution vessel 94 to a tensor mechanism 102 and to a driving mechanism 104 in about 350 seconds. During this time the web is contacted with sponges 106 saturated with a buffer solution to prevent the web 12 from drying. It takes approximately 20 minutes for the web to complete a loop around the apparatus.

At this contacting speed and flow rates, 20 ml/min of eluent containing approximately 0.3 units/ml (about 0.0258 mg/ml) asparaginase is obtained from 12 ml/min of a fresh enzyme buffer solution which contains 0.5 units/ml (about 0.043 mg/ml) asparaginase and about 0.06 mg/ml trypsin. Thus, an essentially pure enzyme stream is obtained from the initial mixture.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A chromatographic apparatus comprising
an endless, flexible web supported by a plurality of spindles;
an activated porous matrix layered upon said web;
ligand molecules chemically bound to said matrix layer via spacer arms;
at least one vessel having an inlet and an outlet; wherein
at least one lengthwise portion of the web is positioned within the volume defined by said at least one vessel.

2. The apparatus of claim 1, wherein the porous matrix has a thickness of between about 1 μm to 1000 μm.

3. The apparatus of claim 1, wherein the average pore size of the matrix is between about 10 nm and 100 nm.

4. The apparatus of claim 1, wherein the matrix is an agarose matrix.

5. The apparatus of claim 1, wherein the flexible web is selected from metallic and polymeric.

6. The apparatus of claim 5, wherein the flexible web is polyester.

7. The apparatus of claim 1, wherein the ligand molecules are selected from enzymes, antibodies, lectins, nucleic acid, hormones, and vitamins.

8. The apparatus of claim 1, wherein the web is non-porous.

9. The apparatus of claim 1, wherein said web is perforated along its lengthwise edges, wherein said spindles are sprockets, and wherein the spines of said sprockets are disposed within the perforations of the web such that movement of the spindle provides fixed movement of the web.

10. The apparatus of claim 1, wherein said at least one vessel is in thermal communication with a heating element.

11. The apparatus of claim 1, wherein said at least one vessel is in thermal communication with a cooling element.

12. The apparatus of claim 1, wherein at least a portion of said at least one vessel is constructed of transparent material.

13. The apparatus of claim 1, wherein said apparatus is modular and may be easily assembled and disassembled.

14. A process for separating one or more biological materials from a mixture of biologically active materials, comprising:
coating an endless, flexible web with a porous matrix;
activating sites within said porous matrix;
attaching ligand molecules to the active sites of the porous matrix via spacer arms wherein the ligand molecules have an affinity for the biological materials to be removed from the mixture; and
moving the activated flexible ligand-bound web in continuous motion with respect to a buffer stream which contains the mixture of biological materials.

15. The process of claim 14, wherein the web and buffer stream are moved in a countercurrent relationship to one another.

16. The process of claim 14, wherein the porous matrix has a thickness of between about 1 μm to 1000 μm.

17. The process of claim 14, wherein the average pore size of the matrix is between about 10 nm and 100 nm.

18. The process of claim 14, wherein the matrix is an agarose matrix.

19. The process of claim 14, wherein the web is coated by a pre-metered coating method selected from the group consisting of slot coating, curtain coating, knife coating, and roll coating.

20. The process of claim 19, wherein the solution of matrix material is a solution of agarose dissolved in a boric acid—sodium borate buffer solution.

21. The process of claim 14, wherein the flexible web is selected from metallic and polymeric.

22. The process of claim 21, wherein the flexible web is polyester.

23. The process of claim 14, wherein the step of activating sites within the matrix comprises reacting the matrix with a preparatory reagent.

24. The process of claim 23, wherein the matrix is agarose and the preparatory reagent is cyanogen bromide (CNBr).

25. The process of claim 14, wherein the ligand molecules are selected from enzymes, antibodies, lectins, nucleic acid, hormones, and vitamins.

26. The process of claim 14, wherein the step of moving the flexible web comprises moving the web lengthwise through at least one vessel, wherein solution flows into an inlet and out from an outlet of each said at least one vessel such that the web and solution move in a countercurrent relationship.

27. The process of claim 26, wherein the web is moved at a rate of between about 10 cm/hr and 500 cm/hr.

28. The process of claim 14, further comprising the step of
moving said web lengthwise through an eluent to desorb biological materials from the web matrix.

29. The process of claim 14, wherein the web is non-porous.
